(19) United States
(12) Patent Application Publication
(10) Pub. No.: US 2015/0082720 A1
(43) Pub. Date: Mar. 26, 2015

(54) WIND TURBINE FOUNDATION

(71) Applicant: ALSTOM RENEWABLE TECHNOLOGIES, GRENOBLE (FR)

(72) Inventors: Arturo Rodríguez Tsouroukdissian, Barcelona (ES); Miguel Lanca Coelho, Barcelona (ES); Manuel Santiago López, Barcelona (ES)

(21) Appl. No.: 14/396,371

(22) PCT Filed: May 8, 2013
(86) PCT No.: PCT/EP2013/059573

§ 371 Date: Oct. 22, 2014

Related U.S. Application Data
(60) Provisional application No. 61/669,473, filed on Jul. 9, 2012.

(30) Foreign Application Priority Data
May 9, 2012 (EP) EP 12382171.2

(51) Int. Cl. E02D 5/22; E04H 12/22; F03D 11/04

(52) U.S. Cl. CPC E02D 5/223; F03D 11/045; E04H 12/22; F05B 2240/95; E02B 2017/0043
USPC 52/298

(57) ABSTRACT

It comprises at least one substantially elongated pin associated with a wind turbine tower and at least one corresponding substantially elongated pile to be inserted into a surface and adapted for receiving at least one portion of the pin. A chamber is defined between the pin and the pile for receiving grout. At least one of the pin and the pile is provided with connecting plates extending inside the grouting chamber and provided with holes through which the grout passes. The connecting plates may extend radially inside the grouting chamber, aligned or not to each other or with the center of the pin or the pile.

This application claims the benefit of European Patent Application EP 12382171.2 filed May 9, 2012 and U.S. Provisional Patent Application Ser. No. 61/669,473 filed Jun. 9, 2012.

A foundation for a wind turbine is disclosed herein. The present wind turbine foundation is particularly suitable for, but not limited to, wind turbine pile foundations in offshore structures. A wind turbine comprising such a foundation is also disclosed herein.

### BACKGROUND

Several types of foundations are known in the art for wind turbine applications. One common type of foundation, which is particularly well known in many offshore structures, is a piled foundation. Piled foundations are widely used for transferring structural loads to the ground.

Piled foundations may consist of one pile, referred to as mono-pile foundations, or a number of piles arranged in different ways according to the requirements.

Piles consist of steel elongated pieces intended to be driven into a surface, such as the ground or the seabed. Piles are shaped for receiving corresponding pins.

Pins are elongated connecting members extending downwards from a wind turbine foundation.

A jacket is a lattice substructure that comprises a number of tubes connected to each other by means of bracings and tubular joints. A transition piece connects and supports the lower part of the wind turbine tower to the substructure.

When the pins are inserted into the corresponding piles a high performance concrete-like mass such as grout is injected. Grout injection serves the purpose of establishing a firm connection between the piles and the pins. Grout injection also helps to avoid undesirable horizontal deflections and inhibit corrosion. Grout provides an increased energy absorption capacity to the structure. Grout is injected typically through the bottom of a chamber formed between the pile and the pin thus forming a grouted joint. The width of the chamber or annulus between the pile and the pin can be maintained constant through the use of centralizers.

The above grouted joints are well known in offshore oil and gas structures. Such fields are however dynamically totally different from the field of wind turbine foundations.

The piles in a wind turbine foundation are subjected to highly cyclic tension and compressive loading due to the wind and waves action. The substructure formed by the transition piece and the foundation is under high hydrodynamic and aerodynamic loads. Such loads are transferred from the tower, the nacelle and the rotor structure of the wind turbine to the seabed. Demands for higher power output and the decrease in the number of sites with high wind availability and good access cause wind farms to have larger turbines that must be mounted higher and thus be more inaccessible. Wind turbine substructures must be thus oversized in order to withstand high loads, making their manufacturing and installation processes undesirably costly.

For increasing load capacity and stiffness of the pile-pin connection the use of shear keys are known and used in the art. Shear keys consist of spaced weld beads or steel bars that are welded on the inner surface of the piles and on the outer surface of the pins. In use, the shear keys are intended to be in contact with the grout once injected within the chamber. This solution is currently used in known offshore wind turbine foundations for the transfer of shear forces. It has been proven to be efficient particularly in increasing the sliding resistance between the grout and the pile and the pin. One example of the use of shear keys is disclosed in US2006185279.

Shear keys however require welding on the outer surfaces of the pins and on the inner surfaces of the piles. This is involves costly and complex operations and often require several welding passes.

A more efficient yet cost effective grout connection would be desirable for wind turbine structures, especially for offshore structures, in order to make wind energy industry projects more economically feasible.

### SUMMARY

A foundation for a wind turbine is disclosed herein. The foundation comprises at least one substantially elongated pin associated with a wind turbine tower and at least one corresponding substantially elongated pile to be inserted into a surface and adapted for receiving at least one portion of a length of the pin when in use, a grouting chamber being defined between the pin and the pile when in use for receiving grout, wherein at least one of the pin and the pile is provided with at least one connecting plate extending inside the grouting chamber, the connecting plate being provided with holes through which the grout passes when in use.

The present wind turbine foundation is particularly suitable for, but not limited to, wind turbine pile foundations in offshore structures. A wind turbine comprising such a foundation is also disclosed herein.

The present wind turbine foundation is intended for connecting a wind turbine tower to a surface, such as the seabed in an offshore wind turbine.

The present wind turbine foundation comprises at least one substantially elongated pin, which is associated with a wind turbine foundation, and at least one corresponding pile to be inserted into the seabed. Definitions are given below.

As used herein, a pin refers to an elongated connecting member, made e.g. of steel, extending downwards from a wind turbine foundation substructure. The pins have a connecting end to be attached to the wind turbine tower through said turbine foundation substructure, and an inserting end, opposite the connecting end. In preferred examples the pins may be cylindrical in shape.

The wind turbine foundation may comprise a jacket consisting of a lattice substructure that comprises a number of tubes. The tubes are connected to each other by means of bracings, tubular joints and the like. A transition piece connects and supports the lower part of the wind turbine tower to the jacket.

As used herein, a pile consists of an elongated connecting member, made e.g. of steel. The piles are driven several tens of meters into a surface such as the ground in the case of onshore wind turbines or such as the seabed in the case of offshore wind turbines. The piles are shaped for receiving at least one portion or section of the length of corresponding pins, that is, the pins can be at least partially inserted, i.e. through their inserting ends, into the corresponding piles when in use. For this purposed, the inserting end of the pins may be guided. In preferred examples the piles may be cylindrical in shape.

A grouting chamber in the form of an annular space is defined between the pin and the pile when in use, that is, when the pin is at least partially inserted into the corresponding pile. Such grouting chamber defined between the pin and the pile is suitable for receiving grout.

As used herein, the term grout includes any cementitious settable material or mixture of settable materials. Grout is used for the support of the present wind turbine foundation. The grout connection thus formed is subjected to compressive and shear load transfer at the chamber.

At least one of the pin and the pile in the present wind turbine foundation is provided with one or more connecting plates made, e.g. of high grade steel, extending inside the grouting chamber. The connecting plates are provided with one or more holes through which the grout passes when in use.

The arrangement of the connecting plates is such that their length dimension extends lengthwise within the chamber and their width dimension extend through the gap of the chamber defined between the pile and the corresponding pin at least partially fitted therein. In some cases, at least one portion of such length and width dimensions could extend out of the grouting chamber.

One example of connecting plates is the so called Perfobond connectors. Perfobond connectors consist of plates with several openings or holes formed therein. Holes are preferably circular but they can assume other shapes such as oval or polygonal as required. Perfobond connectors are mainly defined by the number and size of the openings or holes, the number of plates and their length and width, and the spacing of the openings or holes. These parameters can be conveniently varied according to the wind turbine foundation characteristics. For example, in a typical offshore wind farm it is preferred that the ratio of the distance between the centers two adjacent holes in a connecting plate to the diameter of the holes ranges from 2.20 to 2.40. For example, the number of connecting plates may range from 2 to 16. For example, the ratio of the distance between two adjacent connecting plates to the perimeter of at least one of the pin and the pile may range from ½ to 1/16.

The above wind turbine foundation provides a very strong connection of the wind turbine to the ground with a high load capacity in terms of high shear resistance. Perfobond connectors are highly efficient in high axial loaded structures such as piled foundations in offshore wind turbines. Since the load transition takes place by the grout passing through the holes in the plate, higher compression capacity can be allowed and therefore an increased shear resistance.

As stated above, the pins or the piles, or both the pins and the piles, in the present wind turbine foundation may be provided with such connecting plates. In any case, the connecting plates can easily be welded by a single weld pass to the pins or piles (or both) such that the connecting plates extend inside the chamber. The connecting plates may radially extend inside the chamber.

In this regard, several implementations are envisaged. Both the pin and the pile may be provided with connecting plates. At least some of the connecting plates may extend along at least one section or portion of the length of the at least one of the pin and the pile within the chamber. At least some of the connecting plates may extend inside the chamber such that they are not aligned with the center of at least one of the pin and the pile. Yet in further examples, at least some of the connecting plates may be radially distributed along the perimeter of the at least one of the pin and the pile. Other implementations of the present wind turbine foundation are also envisaged in which at least some of the connecting plates of the pin are substantially aligned with at least some of the corresponding connecting plates of the pile. The aligned connecting plates of the pin and the pile may extend substantially covering the width of the grouting chamber. Still in further examples, at least some of the connecting plates may be arranged symmetrically around the surface of at least one of the pin and the pile.

At least some of the pins may have a guiding end arranged opposite to its connection with the wind turbine and a stopping element extending, e.g. radially, inside the grouting chamber adapted to receive said guiding end such that when the pile is inserted into the pile the guiding end is fitted in the stopping element. In some cases, the guiding end may comprise a protruding element for centralizing the pin when mounting it into a pile.

The stopping element may comprise a cup, e.g. made of a high grade polymer, intended to be received into a central seat formed in the stopping element and wherein it further comprises a disc radially extending from the central seat towards the inner side of the pile.

The stopping element may be welded to the inner wall of the pile. Other ways for attaching the stopping elements to the piles are not ruled out. The stopping element could be also even formed integrally with the pile.

Yet in further implementations, the stopping element may further comprise a disc radially extending from the central seat towards the inner side of the pile.

The stopping element may also have a plurality of bars radially extending from the central seat towards the inner side of the pile. Disc segments may be provided in between the bars.

With the above defined wind turbine foundation a good fatigue resistance structure is obtained which is particularly useful in offshore wind turbine foundations. The present wind turbine foundation may be however useful in onshore wind turbine foundations.

The higher load capacity of the present wind turbine foundation over prior art foundations in which headed stud connectors or shear keys are used renders the present wind turbine foundation very advantageous for wind turbine applications. It has been shown that the connection behaviour until maximum loads are reached is essentially elastic as opposed to what happens in prior art solutions where important plastic slip is developed when maximum loads have been attained.

A more effective shear transfer is thus obtained by using the present robust, reliable, and easy to manufacture and install wind turbine foundation. This is mainly due to the improved load path transmission between the piles and pins and the grout within the chamber. The present wind turbine foundation provides a stiff and ductile connection of the wind turbine foundation to the seabed, which connection has excellent fatigue resistance.

Additional objects, advantages and features of implementations of the present wind turbine foundation will become apparent to those skilled in the art upon examination of the description, or may be learned by practice thereof.

### BRIEF DESCRIPTION OF THE DRAWINGS

Particular implementations of the present wind turbine foundation will be described in the following by way of several non-limiting examples, with reference to the appended drawings, in which:

FIG. 1 is a general elevational view of an offshore wind turbine;

FIG. 2 is a diagrammatic part view of one example of the present wind turbine foundation;

FIG. 3a is an elevational sectional view of one example of the present wind turbine foundation in which one pin is shown fitted in one corresponding pile, with the pin fitted with connecting plates;

FIG. 3b is a elevational sectional view of an alternative example to the wind turbine foundation in FIG. 3a in which both the pin and the pile is fitted with connecting plates;

FIG. 3c is a diagrammatic enlarged elevational view of a connecting plate of the Perfobond connector type;

FIGS. 4a-4e are top plan views of pin-pile arrangements showing different examples of the wind turbine foundation according to different connecting plate arrangements within the grouting chamber;

FIG. 5 is an enlarged elevational sectional view of the example shown in FIG. 3a or 3b;

FIG. 6 is a top plan view of a further example of the present stopping element; and

FIG. 7 is a perspective sectional part view of the example of the present stopping element in FIG. 6.

### DETAILED DESCRIPTION OF EMBODIMENTS

Several examples of the wind turbine foundation are shown in the figures which will be disclosed herein as non-limiting examples. Like reference numerals refer to like parts throughout the description of the figures.

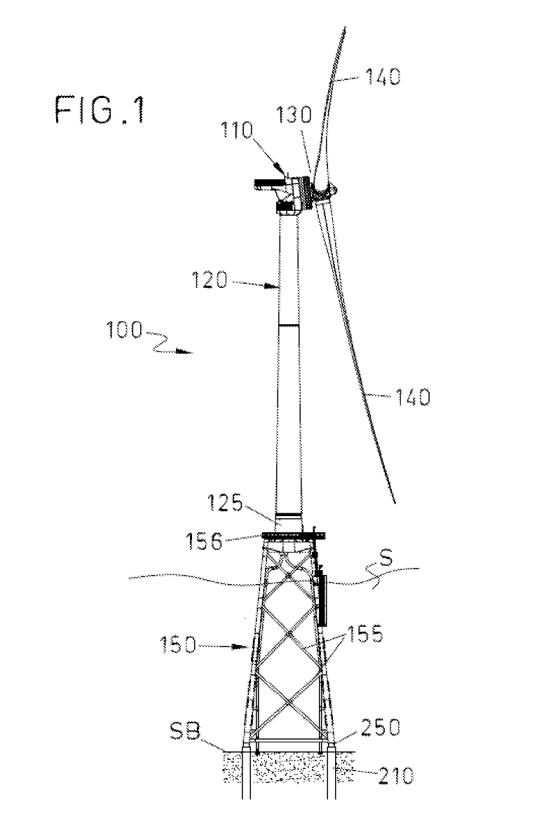

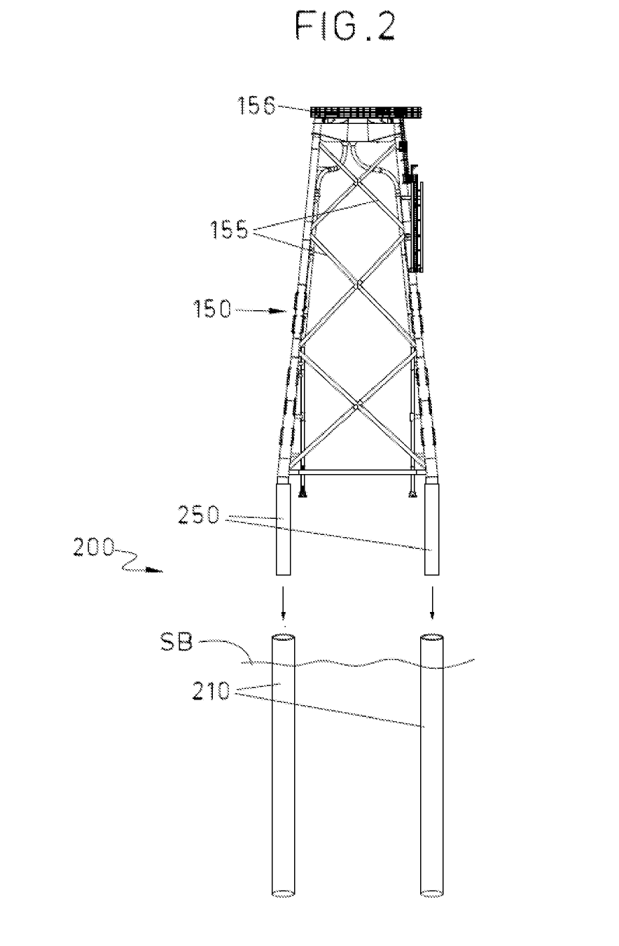

FIG. 1 generally shows an offshore wind turbine 100 installed on the sea S. The offshore wind turbine 100 mainly comprises a nacelle 110 that is fitted at the upper end of a tower 120. The nacelle 110 of the offshore wind turbine 100 is provided with a rotor hub 130 provided with blades 140 for capturing the action of the wind for electricity production.

In the particular and non-limiting example shown in the figures, the wind turbine foundation comprises a jacket substructure 150 provided at a platform 156 in the bottom portion of a transition piece 125. The jacket substructure 150 is formed of a number of tubes 155 connected to each other. The transition piece 125 is provided for connecting the platform 156 to the bottom portion of the wind turbine tower 120 as shown in FIG. 1 of the drawings.

Apart from the above configuration for the wind turbine foundation, comprising (from top to bottom) a transition piece 125, a platform 156 and a jacket substructure 150, other configurations could be also possible, such as those comprising (from top to bottom) a transition piece 125 and a jacket substructure 150, and a small platform attached to the jacket or the transition piece which is only for operations of maintenance and access purposes.

The wind turbine foundation 200 connects the wind turbine tower 120 through the jacket substructure 150 with the seabed SB.

In the present particular non-limiting example, the wind turbine foundation 200 comprises four piles 210. Piles 210 consist of elongated cylindrical connecting members made of steel. Piles 210 are driven, i.e. inserted, into the seabed SB.

The wind turbine foundation 200 further comprises corresponding four substantially elongated cylindrical pins 250. Each pin 250 has a connecting end and an opposite, inserting end. The pins 250 are attached to and extend downwards from the jacket substructure 150 of the wind turbine 100 through their connecting ends.

The piles 210 are shaped and sized for receiving the inserting end of the pins 250 so that at least one portion of the length thereof is accommodated therein. For this purpose the inner diameter of the piles 210 is larger than the outer diameter of the corresponding pins 250. The inserting end of the pins 250 may be guided and they may also be slightly tapered for ease of insertion into the piles 210.

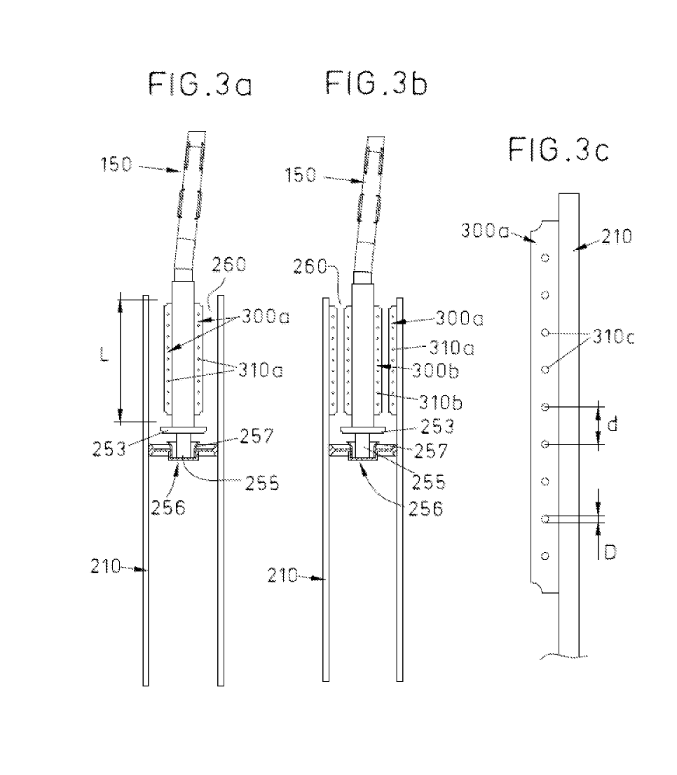

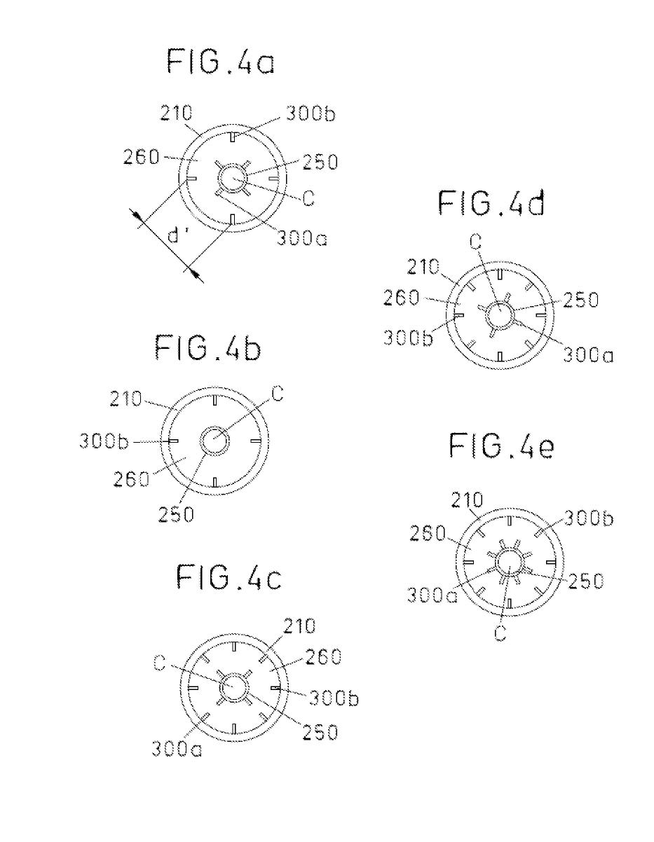

A grouting chamber 260 is defined. It is formed by the annular space between the pins 250 and the piles 210 when the former are at least partially inserted into the latter. The grouting chamber 260 of the wind turbine foundation 200 is suitable for receiving grout. FIGS. 3a-3b and 4a-4e clearly shows the grouting chamber 260.

A number of connecting plates, 300a, 300b are provided. Examples of connecting plates, 300a, 300b are shown in FIGS. 3a-3c and 4a-4e of the drawings. They can be steel connecting plates 300a, 300b attached to the pins 250 or the piles 210 (or both) such that the plates 300a, 300b radially extend inside the chamber. Attachment of the connecting plates 300a, 300b to the piles 210 and/or pins 250 may be carried our through a single weld pass process.

A number of implementations are envisaged for the connecting plates 300a, 300b. Some of said implementations are briefly explained below. The following arrangements can be combined with each other.

For example, there could be only connecting plates 300a attached to the pins 250, as shown in FIG. 3a, or to the piles 210, as shown in FIG. 4b. Alternatively, there could be connecting plates 300a attached to the pins 250 and there could be also connecting plates 300b attached to the piles 210, such as shown in FIGS. 3b, 4a, 4c, 4d and 4e of the drawings.

In any case, a number of connecting plates 300a, 300b in range from 2 to 16 is preferred. For example, each of the pile 210 and the pin 250 are both provided with four connecting plates 300a, 300b in FIG. 4a. Alternatively, in FIG. 4b the pile 210 is provided with four connecting plates 300b. In the example in FIGS. 4c and 4d, the pile 210 is provided with eight connecting plates 300b while the pin 250 is provided with four connecting plates 300a. In FIG. 4c four connecting plates 300a are provided which are aligned with corresponding four of the eight connecting plates 300b of the pile 210. In FIG. 4d four connecting plates 300a are provided which are not aligned with corresponding four of the eight connecting plates 300b of the pile 210. Finally, in FIG. 4e each of the pile 210 and the pin 250 are both provided with eight connecting plates 300a, 300b that are not aligned with each other.

At least some of the connecting plates 300b of the pin 250 may be substantially aligned with at least some of the corresponding connecting plates 300a of the pile 210 as shown in the example in FIG. 4c.

At least some of the connecting plates 300a, 300b may extend a length L of at least one of the piles 210 and the pins 250 within the chamber 260 as shown in FIGS. 3a and 3b. However, at least some of the connecting plates 300a, 300b of at least one of the piles 210 and the pins 250 could project outwards the chamber 360.

At least some of the connecting plates 300a, 300b may extend at least partially across the inside of the grouting chamber 260 as shown in FIGS. 3a and 3b and 4a-4e.

Although not shown, at least some of the connecting plates 300a, 300b may extend inside the chamber 260 such that they are not aligned with the center C of the pin 250 and/or the pile 210.

At least some of the connecting plates 300a, 300b may be radially distributed along the perimeter of the pin 250 and/or the pile 210 as shown in FIGS. 3a and 3b and 4a-4e.

At least some of the connecting plates 300a, 300b may be arranged symmetrically around the surface of the pin 250 and/or the pile 210. The connecting plates 300a, 300b may evenly distributed on the perimeter of the pin 250 and/or the pile 210 although in some cases the connecting plates 300a, 300b may arranged only in some portions of the perimeter of the pin 250 and/or the pile 210.

In any of the above cases, at least some of the connecting plates 300a, 300b are of the Perfobond type. More specifically, they are longitudinal plates provided with a number of holes 310a, 310b. Holes 310a, 310b are sized suitably such that the grout inside the chamber 260 passes when in use, that is when the pins 250 are at least partially inserted into corresponding the piles 210. In the present examples, the holes 310a, 310b in the Perfobond connecting plates 300a, 300b are circular in shape. Other suitable shapes are however not ruled out.

In the example illustrated in FIG. 3c, some design parameters of a Perfobond connecting plate 300a are depicted. In the example in FIG. 3c the ratio of the distance d between the centers of two adjacent holes 310a in a connecting plate 300a to the diameter D of the holes 310a in said connecting plate 300a is shown. In said example, such ratio lies from 2.20 to 2.40. In some cases, the ratio of the distance d′ (see FIG. 4a) between two adjacent connecting plates to the perimeter of the pin 250 or the pile 210, or both the pin 250 and the pile 210, may range from ½ to 1/16.

Turning back to FIGS. 3a and 3b of the drawings, the inserting end of at least some of the pins 250 may be a guiding end 255. The guiding end 255 is provided at a lower portion of the pins 250, opposite to the connection end of the pin 250 where the pin 250 is connected with the tower 120 of the wind turbine 100.

A stopping element 256 may be also provided. The stopping element 256 is radially arranged, welded to an inner wall 211 of the pile 210 within the grouting chamber 260 extending radially therein. Specifically, the stopping element 256 is arranged inside the pile 210 on a plane substantially transversal to a longitudinal axis 252 of the pile 210 as shown in FIGS. 3a, 3b, and 5-7.

The stopping element 256 is adapted to receive the guiding end 255. As shown in said FIGS. 3a, 3b and 5-7 the stopping element 256 includes a central seat 254 provided with a cup 257 made of a polymeric material such as a high grade polymeric material in which cup 257 the guiding end 255 of the pin 250 is fitted. A disc 258 is also provided extending radially between the central seat 254 and the inner wall 211 of the pile 210.

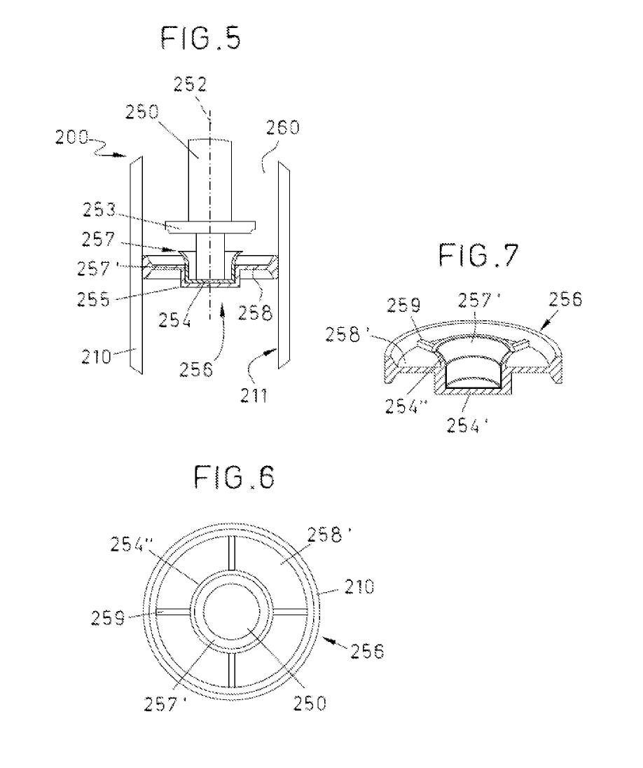

The cross-section of the guiding end 255 is smaller than that of the rest of the pin 250. In the intersection of the cross-section of the guiding end 255 and the pin 250, the pin 250 has a protruding element, e.g. an annular ring or disc 253 for centralizing the pin 250 when it is being inserted into the pile 210. This can be seen in FIGS. 3a, 3b and 5.

The central seat 254′ in the example of FIGS. 6 and 7 comprises an upward protrusion 254″. This upward protrusion 254″ is integrally formed with the central seat 254′ such that both, the central seat 254′ and the upward protrusion 254″, define a cup shaped seat. The cup shaped seat comprises a cup body 257′ made of a polymeric material such as a high grade polymeric material. The cup body 257′ as shown in the FIGS. 6 and 7 is concentrically arranged on the inner surface of the upward protrusion 254″ (and on the central seat inner surface).

In the example shown in said FIGS. 6 and 7 four bars 259 are provided in a cross configuration between the central seat 254 and an inner wall of the pile 210. The bars 259 in any case may radially extend between the central seat 254, 254′ and the inner wall of the pile 210. Disc segments 258′ are also provided in between these bars 259.

Although only a number of particular implementations and examples of the present wind turbine foundation have been disclosed herein, it will be understood by those skilled in the art that other alternative implementations and/or uses and obvious modifications and equivalents thereof are possible. Furthermore, the present disclosure covers all possible combinations of the particular examples described. Thus, the scope of the present disclosure should not be limited by particular examples, but should be determined only by a fair reading of the claims that follow.

1. A wind turbine foundation, comprising:
at least one substantially elongated pin associated with a wind turbine tower and at least one corresponding substantially elongated pile to be inserted into a surface and adapted for receiving at least one portion of a length of the pin when in use; and
a grouting chamber being defined between the pin and the pile when in use for receiving grout;
wherein at least one of the pin and the pile is provided with at least one connecting plate extending inside the grouting chamber, the connecting plate being provided with holes through which the grout passes when in use.

2. The wind turbine foundation of claim 1, wherein a plurality of connecting plates are arranged such that they radially extend inside the grouting chamber.

3. The wind turbine foundation of claim 1, wherein a plurality of connecting plates are arranged extending from at least one of the pin and the pile such that they are not aligned with a center of at least one of the pin and the pile.

4. The wind turbine foundation of claim 1, wherein a plurality of connecting plates are radially distributed along a perimeter of the at least one of the pin and the pile.

5. The wind turbine foundation of claim 1, wherein a plurality of connecting plates extend along at least one length of the at least one of the pin and the pile.

6. The wind turbine foundation of claim 5, wherein a plurality of connecting plates are attached to the at least one of the pin and the pile by a single weld pass.

7. The wind turbine foundation of claim 1, wherein a number of connecting plates ranging from 2 to 16 are provided extending inside the grouting chamber.

8. The wind turbine foundation of claim 1, further comprising two adjacent connecting plates extending inside the grouting chamber, wherein a ratio of the distance between the two adjacent connecting plates to the perimeter of at least one of the pin and the pile ranges from ½ to 1/16.

9. The wind turbine foundation of claim 1, wherein a ratio of the distance between centers of two adjacent holes in the connecting plate to a diameter of the holes ranges from 2.20 to 2.40.

10. The wind turbine foundation of claim 1, wherein both the pin and the pile are provided with connecting plates, with at least some of the connecting plates of the pin being substantially aligned with at least some of the corresponding connecting plates of the pile.

11. The wind turbine foundation of claim 10, wherein a plurality of connecting plates extend substantially across a width of the grouting chamber.

12. The wind turbine foundation of claim 1, wherein a plurality of connecting plates are arranged symmetrically around a surface of at least one of the pin and the pile.

13. The wind turbine foundation of claim 1, wherein both the pin and the corresponding pile are cylindrical in shape.

14. The wind turbine foundation of claim 1, further comprising a plurality of pins and a plurality of piles, each pile for receiving the at least one portion of the length of the corresponding pin when in use, wherein at least some of the pins have a guiding end arranged opposite to a connecting end, the connecting end being associated with the wind turbine tower, and a stopping element extending inside the grouting chamber, the stopping element being adapted to receive the guiding end of the pin when the pin is inserted into the pile.

15. The wind turbine foundation of claim 14, wherein the stopping element further comprises a plurality of bars radially extending between a central seat and an inner surface of the pile.

16. A wind turbine comprising:
a wind turbine foundation, the foundation comprising:
at least one substantially elongated pin associated with a wind turbine tower and at least one corresponding substantially elongated pile to be inserted into a surface and adapted for receiving at least one portion of the length of the pin when in use; and
a grouting chamber being defined between the pin and the pile when in use for receiving grout;
wherein at least one of the pin and the pile is provided with at least one connecting plate extending inside the grouting chamber, the connecting plate being provided with holes through which the grout passes when in use.
